(19) United States
(12) Patent Application Publication
(10) Pub. No.: US 2005/0012628 A1
(43) Pub. Date: Jan. 20, 2005

(54) Stand-alone notification system

(76) Inventors: Steven P. Kadner, Albuquerque, NM (US); Richard Rosley, Albuquerque, NM (US)

Correspondence Address: CARSTENS YEE & CAHOON, LLP, P O BOX 802334, DALLAS, TX, 75380, US

(21) Appl. No.: 10/657,367

(22) Filed: Sep. 8, 2003

Related U.S. Application Data
(60) Provisional application No. 60/488,608, filed on Jul. 18, 2003.

(51) Int. Cl. G01W 1/00

(52) U.S. Cl. 340/601; 340/691.6; 340/539.1

(57) ABSTRACT

The present invention provides for a system, apparatus, and method for broadcasting indications of given conditions. The present invention includes a receiver, a display, and a controller coupled to the display. The display can use symbols and/or colors to indicate the status of one or more conditions. An audible alarm can be included to warn of true emergency situations. The device may be plugged into a two-prong electrical outlet for electrical power. The broadcast can be received either through the outlet wirings or as broadcast on a radio frequency.

### 1. CROSS-REFERENCE TO RELATED APPLICATION

This application claims the benefit of and priority to a U.S. Provisional Patent Application No. 60/488,608 filed Jul. 18, 2003, the technical disclosure of which is hereby incorporated herein by reference.

### BACKGROUND OF THE INVENTION

1. Technical Field:

The present invention relates to a broadcast notification system for both emergency and non-emergency conditions. More specifically, it relates to a device and system for receiving a signal related to a given condition and providing a visual display and/or an audible signal, depending on the type of condition.

2. Description of Related Art:

The need often arises to notify large numbers of people of a given condition, so that they can take appropriate action. These can be immediate, life-threatening emergencies, such as a tornado in the vicinity, or they can non-emergency conditions. Examples of the latter are water restrictions that a city may place on residents during a drought or school closings because of weather conditions.

Traditionally, notifications for emergency or threatening situations are given over the television, radio, or more recently, the Internet. These methods are, of course, effective only if the broadcast device is turned on; persons who are involved in other activities may not realize the need to listen for news. For specific dangers such as tornados, civil defense sirens may also be used for notification. However, sirens only warn of immediate danger, and do not offer a notification, for example, that the area is under a tornado watch or warning. In addition, since the sirens cover a large area, the ability to hear the sirens can be affected by distance, wind, or ambient noise.

For conditions such as school closings due to weather, the information is generally broadcast over radio and television and families generally know to check these sources, but it can be inconvenient to take the time to wait for a particular school's status to be broadcast, especially if a large number of schools and office are closed.

A drought that causes water restrictions presents still another type of situation that requires mass notification. In this case newspaper notices have traditionally supplemented broadcast media in providing updates on any restrictions in effect, such as watering only on certain days and times. There are persons, however, who do not read the local paper, do not listen to broadcast media when such information is typically broadcast, or for other reasons do not find these methods convenient.

It would be advantageous to have a broadcast system that can continuously monitor alerts for given conditions and provide a simple, personalized notification to the user.

### SUMMARY OF THE INVENTION

The present invention provides for a system, apparatus, and method for broadcasting notifications of various conditions, both emergency and non-emergency. The present invention includes a receiver and a controller and can be configured to provide a visual indicator on a display, an audible alarm, or both. The device can be plugged into a two-prong electrical outlet for electrical power. The receiver can receive a broadcast by radio frequency (RF) or by digital signaling through the electrical wiring. The controller decodes the received notifications and controls the visual indicator and or audible alarm, depending on the type of notification necessary.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1A shows a pictorial representation of a broadcast system for remotely providing notification of given conditions according to an embodiment of the invention.

FIG. 1B shows a monitoring device for receiving the broadcast signal according to one embodiment of the invention.

FIG. 2 shows a monitoring device according to an alternate embodiment of the invention.

FIG. 3 shows a monitoring device according to a further alternate embodiment of the invention.

FIG. 4 shows a pictorial representation of the components of the alert system according to an embodiment of the invention.

FIG. 5A shows a flow chart for a simple alert system according to an embodiment of the invention.

FIG. 5B shows a flow chart for a somewhat more complicated system according to an alternate embodiment of the invention.

### DETAILED DESCRIPTION OF THE INVENTION

The invention will now be explained with reference to the figures, which show a number of embodiments of the invention.

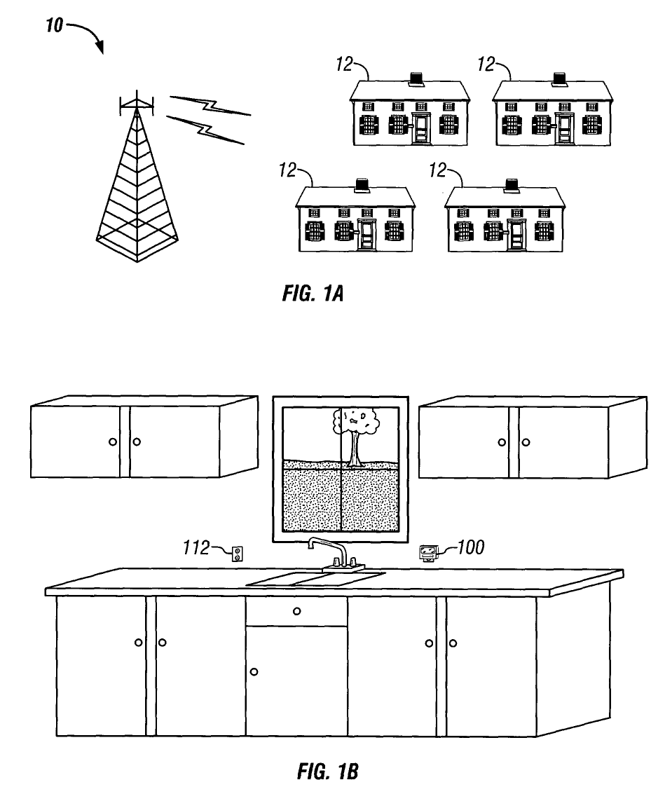

FIG. 1A shows a pictorial representation of a broadcast system for remotely providing mass notification of a condition according to an embodiment of the invention. In this embodiment, a radio frequency (RF) transmitter 10 broadcasts a signal that includes the status of a condition being monitored. The broadcast can be continuous or periodical. The transmitter 10 can be a stand-alone transmitter, dedicated to this notification, or it can be tied into an existing transmission system, such as a radio or television station, with the notification embedded in the regular message stream. The signal is broadcast to a wide area, depending on the strength of the signal, and will be received in homes 12, as well as in other locations, such as businesses. In an alternate embodiment of the broadcast system, a digital signal is embedded in the electrical power provided to the homes and businesses in the region. Persons skilled in the art are aware of how to configure an 110V, 60 Hz electrical power supply with a communications.

First Embodiment: Drought Notification

Turning now to FIG. 1B, we see a monitoring device 100, for receiving the broadcast signal according to one embodiment of the invention. The monitoring device 100 is plugged into a wall socket 112, and has been placed in a location where the user will easily notice it. In this depiction, the device is in the kitchen of a home, although the only requirements are that a supply of electricity must be available, there must be no shielding of RF transmissions, and the device must be in a visible location to be effective.

In this embodiment, the device is very simple and is capable of notifying the user of only one condition: water restrictions due to a drought. Because of this limited scope, the whole face of the device simply displays a color, according to the severity of the restrictions. In this example, a green light is displayed to indicate a normal condition with no restrictions; a yellow light indicates a moderate restriction as designated by the municipality, e.g., even numbered houses can only water the lawns on even days before 6 AM or after 10 PM; a red light indicates a severe drought condition, with no watering allowed.

The advantage of this embodiment is that the user does not need to pick up a paper or remember to listen for current restrictions. The information is updated periodically or even continuously and is available at a glance when the user is ready to receive it.

Alternate Embodiment: Disaster Warnings

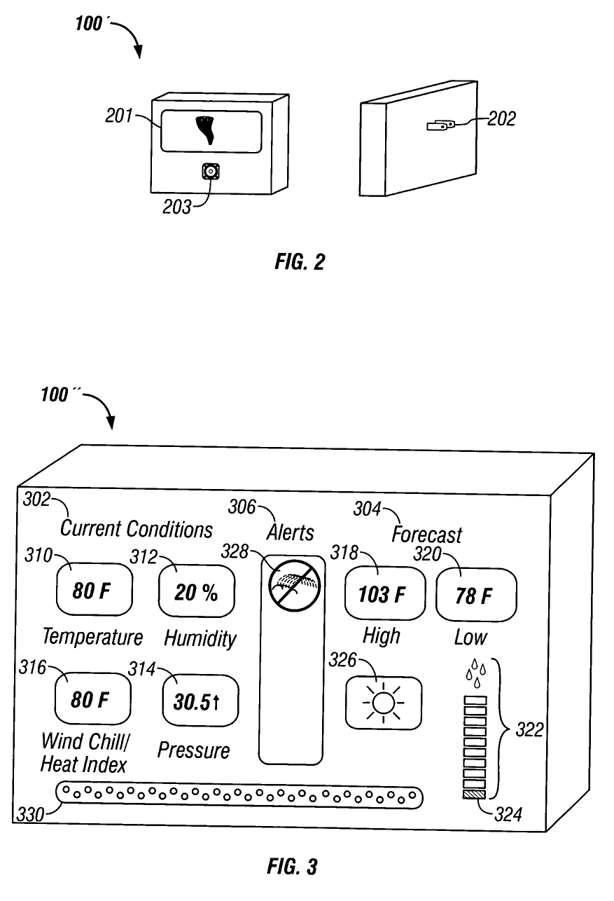

FIG. 2 shows an alternate embodiment in which the monitoring device 100′ is configured to monitor a number of emergency conditions and to notify the user when necessary. In this example, the conditions monitored include tornado, flood, blizzard, and homeland defense. Because of the need for immediate action in at least some of these conditions, the monitoring device contains an audible alarm, seen as speaker 203, as well as a visual display 201; the dual prong plug 202 on the backside of the monitoring device is visible in a view of the backside of the device. In this embodiment, the visual display 201 displays a green light when all of the above conditions are normal. If, for example, the area is placed under a tornado watch, indicating that conditions are conducive to a tornado developing, the monitoring device will receive a signal to this effect. The visual display is changed to yellow, indicating that a moderate level warning is in effect. At the same time, an illustration of a tornado 204 is displayed on the face of the monitor, to identify the specific concern. Optionally, the monitoring device may also sound a low-level warning signal to alert the user to this change. If later a tornado is spotted in the region, the watch is upgraded to a warning, meaning that people should immediately seek appropriate shelter. When the monitoring device of the present embodiment is notified of the warning, the illustration of a tornado remains, while a red light is turned on to indicate the severity of the condition, while an audible alarm is sounded to alert the household, who may or may not be paying attention to the weather. Because several conditions are being monitored, the audible alarm can be designed with different signals for each condition. For example, a tornado can have a continuous tone, a flood can have a short beeping tone, a blizzard can have a long beeping tone, and homeland defense can have an undulating siren. In each case, the alarm will be sounded as long as the alert continues, or alternatively, a shut-off button can be added to turn off the alarm once its message has been received. Along with the audible warning, a display will always indicate the specific concern.

Third Embodiment: Generalized Weather Conditions

In a third embodiment, the system is used to notify users of a variety of weather conditions, as seen in FIG. 3. Because a variety of information is presented, the face of the device is much larger than in previous versions. In this embodiment, three sections can be seen on the device: current conditions 302, the forecast 304, and alerts 306. Within current conditions 302, the current temperature 310, humidity 312, and atmospheric pressure 314 are shown, as well as either the heat index (in the warmer months) or the chill factor (in cooler months) 316. The forecast 304 shows the predicted high 318 and low 320 for the day, as well as the chance of precipitation 322. The chance of precipitation is given as a bar graph, with ten small lights 324, each representing a 10% probability of rain. In the example shown, the chance of rain is 10%, so one indicator is turned on. The predicted conditions 326, e.g., cloudy, sunny, rainy, snow, etc., can be shown using symbols. Weather alerts, such as wind (for areas near water), freezing weather, drought, and tornados are indicated in the display area 327 under the title Alerts. Like earlier versions, this display can used lights, such as green, yellow, and red, to indicate the severity of the condition. Finally, the device includes a speaker 330, used when a life-threatening condition is noted, such as a tornado. In the circumstances shown in the figure, the user is alerted to the fact that the current temperature 310 is 80° F., as is the heat index 316; the humidity 312 is 20% and the pressure 314 is 30.5 and rising. The forecast is for a high 318 of 103° F. and a low 320 of 78° F., with sunny skies 326 and only a 10% chance of rain 322. The area is also under severe drought conditions, as the alerts show that watering is not allowed 328. As well as serving as a stand-alone device, the weather display can alternatively be combined with a weather radio, so that conditions are always displayed, but the user can tune in for more details if desired.

Fourth Embodiment: Localized Conditions

Because the signal can be received on a radio frequency, it is possible in a fourth embodiment of the invention, to provide notification of a more localized condition. For instance, a neighborhood could use a low-power transmitter with a range, for example, of one mile, to notify residents when bulky trash can be set out on the curbside or to signal when a neighborhood pool is open. A neighborhood school could signal when school is closed, either for scheduled days off or weather. Such localized embodiments can utilize a frequency that is separate from the frequency used for widespread notification.

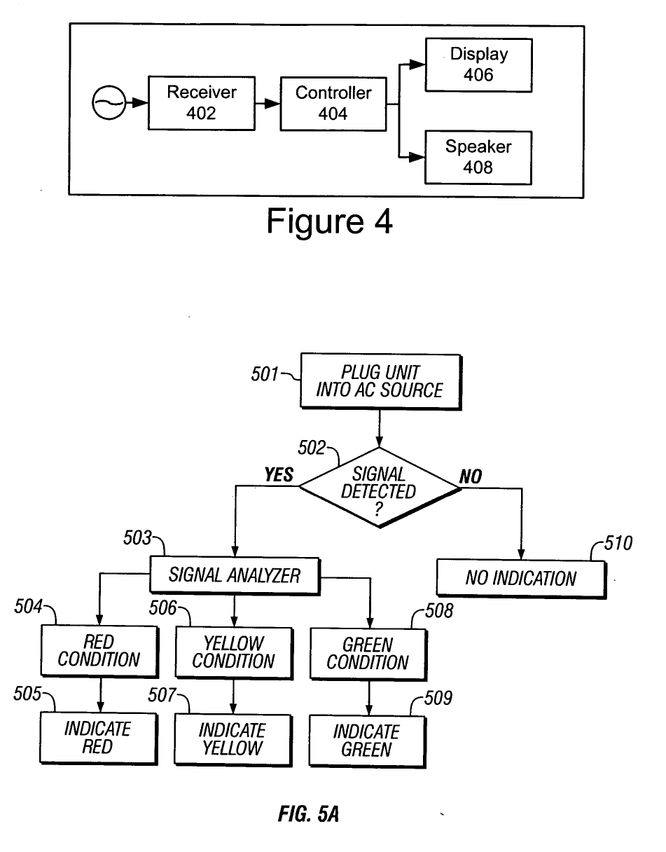

Referring now to FIG. 4, the notification system is depicted by a pictorial representation of its components in accordance with an embodiment of the present invention. The components include a receiver 402, controller 404, display 406, and speaker 408. The receiver 402 receives a broadcasted signal that carries information regarding the condition or conditions of interest. Receiver 402 can receive radio frequency (RF) signals over the airways or digital signals over the electrical wiring. If received through radio frequency, the Federal Communications Commission (FCC) determines the receiver's frequency, so that the broadcast does not interfere with other RF channels. If received through an electrical outlet, the receiver 402 can receive a signal through a standard 2-prong power outlet. Once the broadcasted signal is received, receiver 402 passes the received signal to controller 404. Controller 404 decodes the received signal and determines its significance. Depending on the configuration of the system, the controller will control one or both of the display 406 and the speaker 408. The number, type, and severity of conditions being monitored will determine the complexity of the programming for the controller 404 and its output connections.

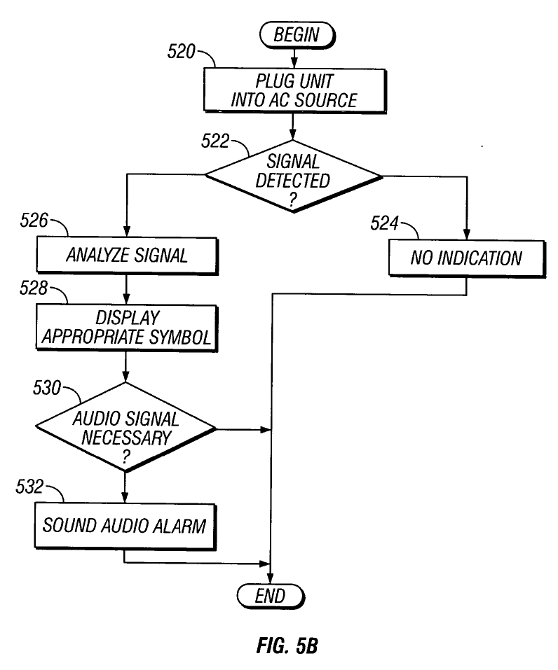

Referring now to FIG. 5A, we see a flow chart for a simple system, such as device 100 of FIG. 1. First, notification device 100 is plugged into an electrical outlet for a power source (step 501). The receiver detects and receives a signal (step 502). If no signal is detected, the no indication is given to light indicator 100. The received signal is analyzed and decoded by the controller into a given status (step 503). The status indicates the condition and the degree of severity of the condition. In a situation where drought is the emergency condition, drought status includes three types of conditions: (a) normal condition in which no drought condition exists (step 504); (b) drought warning in which a drought is in the forecast and drought is likely without replenishment of main water resources (step 506); (c) severe drought condition in which a drought condition is prolonged and has become severe for the community (step 508). Once the status is decoded, the controller selects and enables either a green light in response to a normal condition (step 505), yellow light in response to a drought warning (step 507), or red light in response to a severe drought condition (step 509).

FIG. 5B gives a flowchart for a somewhat more complicated system, such as the device 100′ of FIG. 2. In this embodiment, as the unit is plugged in (step 520), it begins looking for a signal (step 522). If no signal is detected, no indication can be given (step 524). Otherwise, the signal is analyzed (step 526) to determine its meaning. An appropriate signal is lighted in response to the signal (step 528), then the controller determines if an audio signal is to be provided (step 530). If appropriate, the controller sounds an audio signal (step 532); otherwise, the algorithm ends. It will be understood that the flow can be altered as new capabilities are added.

The description of the present invention has been presented for purposes of illustration and description, and is not intended to be exhaustive or limited to the invention in the form disclosed. Many modifications and variations will be apparent to those of ordinary skill in the art. The embodiments were chosen and described in order to best explain the principles of the invention, the practical application, and to enable others of ordinary skill in the art to understand the invention for various embodiments with various modifications as are suited to the particular use contemplated.

1. A device for displaying a broadcast condition, said device comprising:
a receiver for receiving a broadcast signal;
a controller, coupled to said receiver, for decoding said broadcast signal;
a display panel for displaying an indicator of the content of said broadcast signal; and
a power plug, mounted to the display panel, to power said receiver, said controller, and said display panel.

2. The device of claim 1, wherein said display panel displays only a color.

3. The device of claim 1, wherein said display panel displays symbols indicating a condition being reported.

4. The device of claim 1, further comprising an audio alarm that can be sounded by said controller.

5. The device of claim 1, wherein the contents of said broadcast signal is with regard to an emergency condition.

6. The device of claim 1, wherein the contents of said broadcast signal is with regard to a non-emergency condition.

7. The device of claim 1, wherein the contents of said broadcast signal is with regard to a single condition.

8. The device of claim 1, wherein the contents of said broadcast signal is with regard to a plurality of conditions.

9. A method for providing information to a consumer, said method comprising:
receiving, at a device powered by household current, a broadcast radio frequency signal that carries information with regard to a condition;
decoding said information to provide a status; and
in response to said receiving and decoding steps, providing a display that indicates said status.

10. The method of claim 9, wherein said display comprises a selection of colored lights, each of which indicates a known status.

11. The method of claim 9, wherein said display includes symbols that provide information regarding said status.

12. The method of claim 9, wherein the condition is an emergency condition.

13. The method of claim 9, wherein the condition is a non-emergency condition.

14. The method of claim 9, further comprising the step of sounding an alarm when an emergency exists.

15. The method as recited in claim 9 wherein a plurality of conditions are reported.

16. A system for broadcasting given conditions, said system comprising:
a transmitter for transmitting a broadcast signal;
a receiver for receiving said broadcast signal;
a controller, coupled to said receiver, for decoding said broadcast signal;
a display panel for displaying an indicator of the content of said broadcast signal; and
a power plug, mounted to said display panel, to power said receiver, said controller, and said display panel.

17. The device of claim 1, further comprising an audio alarm that can be sounded by said controller.

18. The device of claim 1, wherein the contents of said broadcast signal is with regard to an emergency condition.

19. The device of claim 1, wherein the contents of said broadcast signal is with regard to a non-emergency condition.

20. The device of claim 1, wherein the contents of said broadcast signal is with regard to a plurality of conditions.
